(19) United States
(12) Patent Application Publication
(10) Pub. No.: US 2010/0259228 A1
(43) Pub. Date: Oct. 14, 2010

(54) ELECTRONIC DEVICE AND POWER CHARGING SYSTEM THEREOF

(75) Inventor: Yao-Hwa Chen, Taipei (TW)

Correspondence Address: WPAT, PC;INTELLECTUAL PROPERTY ATTORNEYS, 7225 BEVERLY ST., ANNANDALE, VA, 22003, US

(73) Assignee: ASUSTeK COMPUTER INC., Taipei (TW)

(21) Appl. No.: 12/754,907

(22) Filed: Apr. 6, 2010

(30) Foreign Application Priority Data
Apr. 8, 2009 (TW) 098111694

(51) Int. Cl. H02J 7/04; H02J 7/00

(52) U.S. Cl. 320/162; 320/137

(57) ABSTRACT

A power charging system includes an embedded controller (EC), a control integrated circuit (IC), a current charging IC, and a power converter. The embedded controller outputs a pre-charging signal, a first charging signal, and a second charging signal according to the electricity quantity of the rechargeable battery. The control IC controls a plurality of switches to be on or off to generate a configuration of a plurality of configurations according to the received pre-charging signal, the received first charging signal, and the received second charging signal and correspondingly generates a voltage value according to the configuration. The current charging IC receives the voltage value and outputs a control signal. The power converter converts a direct current outputs to a charging current with a specific value according to the received control signal.

### FIELD OF THE INVENTION

The invention relates to an electronic device and a power charging system thereof and, more particularly, to a power charging system occupying a smaller design space and having eight stage charging currents and a related electronic device thereof.

### BACKGROUND OF THE INVENTION

FIG. 1 is a circuit diagram showing a conventional power charging system. A power charging system 2 of a conventional electronic device 25 is connected between a power adaptor 4 and a lithium ion battery 6, and it mainly includes a current charging integrated circuit (IC) 10, a control circuit 12, a power converter 14, and an embedded controller (EC) 16. The power charging the lithium ion battery 6 is from a direct current outputted by the power adaptor 4, and the power adaptor 4 may supply power to the electronic device 25. When the power adaptor 4 does not supply power to the electronic device 25, the electricity quantity in the lithium ion battery 6 is supplied to an electronic system 20 of the electronic device 25 via the conduction of a power change-over switch (D1). The electronic device may be a notebook computer system, a personal digital assistant (PDA), or a handheld telephone, and the lithium ion battery 6 is a rechargeable battery.

To ensure the safety of charging, the practical electricity quantity of the lithium ion battery 6 should be detected at any time, the value of a charging current (Icharge) charging the lithium ion battery 6 should be adjusted according a detecting result. First, the EC 16 detects the practical electricity quantity in the lithium ion battery 6, and a detecting input end (d) of the EC 16 receives a detecting signal. Afterward, a pre-charging signal PRECHG, a first charging signal BATSEL_2P#, and a second charging signal BATSEL_4P# are outputted to the control circuit 12 according to the result. Then, the control circuit 12 correspondingly changes the voltage of a charging current pin ADJ2 of the current charging IC 10 according to the levels of the three signals. The current charging IC 10 outputs a control signal to the power converter 14 via an output pin OUT according to the voltage value received by the charging current pin ADJ2. The power converter 14 converts a direct current with a specific value outputted by the power adapter 4 to a charging current Icharge which may be dynamically adjusted to output to the lithium ion battery 6 to charge according to the received control signal.

In respect of the current charging IC 10, a charging current (Icharge) outputted to the lithium ion battery 6 may be generated via the following formulas.

When Vadj2 is between 0V to 0.075 volts (V), Icharge=0 A.

When Vadj2 is between 0.075V to Vref, Icharge=(Vadj2−0.075)/(25*RS2).

Wherein Vadj2 is the voltage of the charging current pin, Vref is the voltage of the reference voltage pin VREF, Vref is 5V, and the maximum value of Vadj2 cannot be more than 5V.

Generally speaking, a period of charging the lithium ion battery 6 is divided into two stages, a pre-charging mode and a charging mode. When the EC 16 detects to know that the voltage of the lithium ion battery 6 is smaller than a specific value (such as 3V), the power charging system 2 enters into the pre-charging mode at that moment. In the pre-charging mode, the levels of the pre-charging signal PRECHG, the first charging signal BATSEL_2P#, and the second charging signal BATSEL_4P# outputted by the EC 16 are (High, Low, Low), respectively. In this configuration, a high level pre-charging signal PRECHG received by a gate electrode of a MOS switch M4 in the control circuit 12 makes the MOS switch M4 on. The low level first charging signal BATSEL_2P# and the low level second charging signal BATSEL_4P# received by the gate electrodes of the MOS switches M2 and M3 make the MOS switches M2 and M3 off. The MOS switch M4 which is on makes a resistor Rb first connected with a resistor R4 in parallel and then connected with a resistor Ra in series, and thus the voltage Vref of the reference voltage pin VREF of the current charging IC 10 generates a partial voltage Vadj2 with a specific value to the charging current pin ADJ2. At that moment, the current charging IC 10 outputs a corresponding control signal to the power converter 14 according to the voltage Vadj2 received by the charging current pin ADJ2, and the power converter 14 correspondingly generates the charging current (Icharge, usually 150 mA) to charge the lithium ion battery 6 according to the received control signal.

When the voltage of the lithium ion battery 6 is increased from 3V to another specific value (such as 4.2V) via charging, the power charging system 2 enters the charging mode at that moment. In the charging mode, the level of the pre-charging signal PRECHG outputted by the EC 16 is always a low level (Low). At that moment, the EC 16 may detect the practical voltage of the lithium ion battery 6 and change the levels of the first charging signal BATSEL_2P# and the second charging signal BATSEL_4P# outputted to the gate electrodes of the MOS switches M2 and M3, respectively, and thus the current charging IC 10 makes the power converter 14 generate the charging current Icharge with different values to the lithium ion battery 6 to charge via the control signal outputted to the power converter 14. For example, when the level of the first charging signal BATSEL_2P# is a low level and the level of the second charging signal BATSEL_4P# is a high level according to the practical voltage of the lithium ion battery 6 detected by the EC 16, the MOS switch M3 which is on makes the resistor Rb first connected with resistor R3 in parallel and then connected with the resistor Ra in series, and thus the voltage Vref of the reference voltage pin VREF of the current charging IC 10 generates another partial voltage Vadj2 with a specific value to the charging current pin ADJ2. At that moment, the current charging IC 10 outputs a corresponding control signal to the power converter 14 according to the voltage Vadj2 received by the charging current pin ADJ2, and then the power converter 14 correspondingly generates the charging current (Icharge, such as 0.56 A) to the lithium ion battery 6 to charge according to the received control signal. Similarly, when the level of the first charging signal BATSEL_2P# is a high level and the level of the second charging signal BATSEL_4P# is a low level according to the practical voltage of the lithium ion battery 6 detected by the EC 16, the MOS switch M2 which is on makes the resistor Rb first connected with the resistor R2 in parallel and then connected with the resistor Ra in series, and thus the voltage Vref of the reference voltage pin VREF of the current charging IC 10 generates another partial voltage Vadj2 with a specific value to the charging current pin ADJ2. At that moment, the current charging IC 10 outputs a corresponding control signal to the power converter 14 according to the voltage Vadj2 received by the charging current pin ADJ2, and then the power converter 14 correspondingly generates the charging current (Icharge, such as 1.6 A) to the lithium ion battery 6 to charge according to the received control signal. Similarly, when the levels of the first charging signal BATSEL_2P# and the second charging signal BATSEL_4P# are both low levels according to the practical voltage of the lithium ion battery 6 detected by the EC 16, the MOS switches M2 and M3 are both off. Thus, the voltage Vref of the reference voltage pin VREF of the current charging IC 10 generates another partial voltage Vadj2 with a specific value to the charging current pin ADJ2. At that moment, the current charging IC 10 outputs a corresponding control signal to the power converter 14 according to the voltage Vadj2 received by the charging current pin ADJ2, and then the power converter 14 correspondingly generates the charging current (Icharge, such as 2.8 A) to the lithium ion battery 6 to charge according to the received control signal.

To sum up, when the power charging system 2 is operated in the pre-charging mode, the configuration of the pre-charging signal PRECHG, the first charging signal BATSEL_2P#, and the second charging signal BATSEL_4P# outputted by the EC 16 is (High, Low, Low). At that moment, the power charging system 2 generates the charging current with the specific value (Icharge, 150 mA) to charge the lithium ion battery 6. When the power charging system 2 is operated at the charging mode, the configuration of the pre-charging signal PRECHG, the first charging signal BATSEL_2P#, and the second charging signal BATSEL_4P# may be (Low, Low, High), (Low, High, Low), and (Low, Low, Low). At that moment, the power charging system 2 generates the charging current with the specific value (Icharge, 0.56 A, 1.6 A, or 2.8 A) to charge the lithium ion battery 6. FIG. 2 is a table showing charging currents Icharge correspondingly generated according to the configurations of a pre-charging signal, a first charging signal, a second charging signal.

However, the change of the level of the pre-charging signal PRECHG, the first charging signal BATSEL_2P#, and the second charging signal BATSEL_4P# outputted by the EC 16 may generate eight configurations. The control circuit 12 of the conventional power charging system 2 only uses the four configurations generated by the pre-charging signal PRECHG, the first charging signal BATSEL_2P#, the second charging signal BATSEL_4P# to correspondingly generate the four different partial voltages to the charging current pin ADJ2 of the current charging IC 10, and then only four corresponding control signals are generated to the power converter 14, which causes that the power converter 14 only can generate fourth stage charging currents (150 mA, 0.56 A, 1.6 A, 2.8 A) to charge the lithium ion battery 6. Thus, part of the configurations of the pre-charging signal PRECHG, the first charging signal BATSEL_2P#, and the second charging signal BATSEL_4P# are wasted. Furthermore, the control circuit 12 mainly composed of the MOS switches M2, M3, and M4 occupies too large design space of the power charging system 2.

### SUMMARY OF THE INVENTION

A power charging system is connected between a power adaptor and a rechargeable battery, and the rechargeable battery is used for supplying power to an electronic system of an electronic device. The power charging system includes an embedded controller (EC), a control integrated circuit (IC), a current charging IC, and a power converter. The embedded controller is connected with the rechargeable battery and used for outputting a pre-charging signal, a received first charging signal, and a received second charging signal according to the electricity quantity of the rechargeable battery. The control IC controls a plurality of switches to be on or off to generate a configuration of a plurality of configurations according to the level of the received pre-charging signal, the first charging signal, and the second charging signal and correspondingly generates a voltage value according to the configuration. The current charging IC receives the voltage value via a charging current pin and outputs a control signal according to the voltage value. The power converter converts a direct current outputted by the power adaptor to a charging current with a specific value according to the received control signal to charge the rechargeable battery.

The invention provides a power charging system, the power charging system may correspondingly change the voltage value of the charging current pin of the current charging IC according to eight configurations generated via the change of the levels of the received pre-charging signal, the first charging signal, and the second charging signal, and then eight stage charging currents may be generated, and thus the charging current is further subdivided. Additionally, since the control circuit in the conventional power charging system is replaced by the control IC according to the invention, the design space for the power charging system is further reduced.

### BRIEF DESCRIPTION OF THE DRAWINGS

These and other features, aspects and advantages of the present invention will become better understood with regard to the following description, appended claims, and accompanying drawings.

FIG. 1 is a circuit diagram showing a circuit of a conventional power charging system;

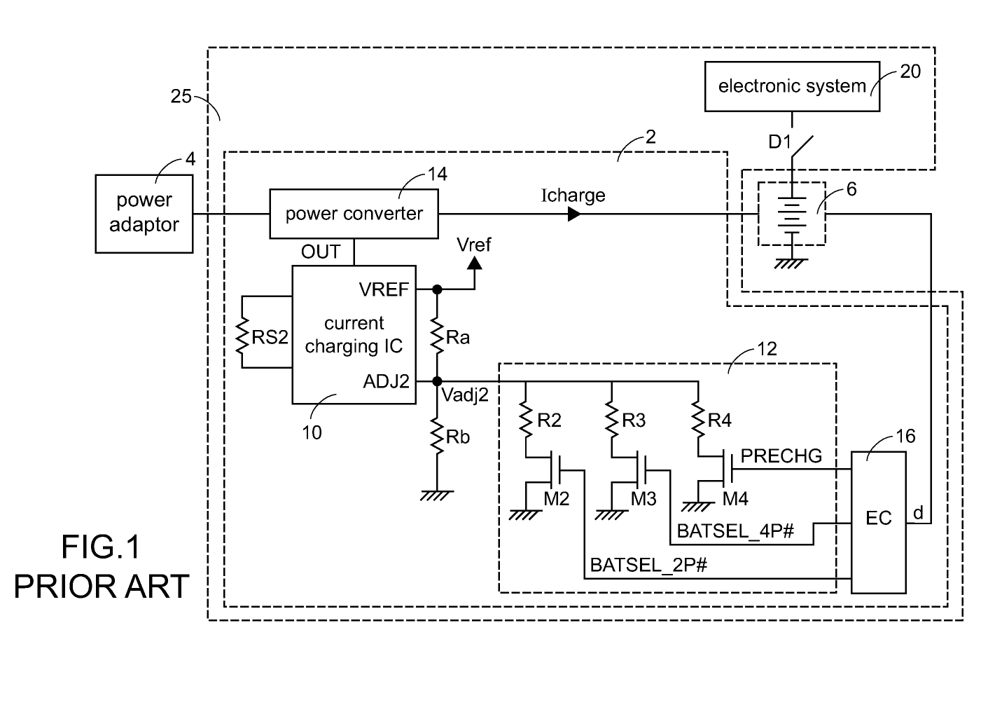

FIG. 2 is a table showing charging currents correspondingly generated according to the configurations of a pre-charging signal, a first charging signal, a second charging signal; and

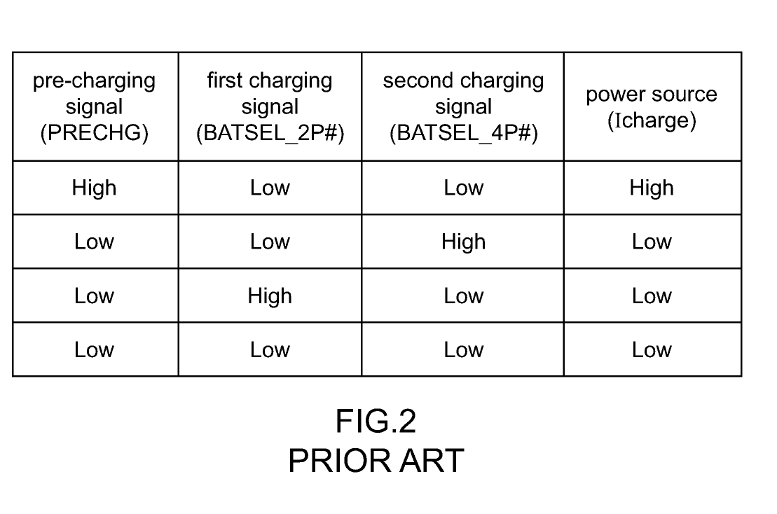

FIG. 3 is a circuit diagram showing a power charging system according to an embodiment of the invention.

### DETAILED DESCRIPTION OF THE PREFERRED EMBODIMENT

A power charging system according to the invention mainly utilizes a control IC to replace a conventional control circuit 12, and the control IC generates eight corresponding specific partial voltages to a charging current pin ADJ2 of a current charging IC 10 according to eight configurations generated by a received pre-charging signal PRECHG, a first charging signal BATSEL_2P#, and a second charging signal BATSEL_4P#, and then the current charging IC 10 correspondingly outputs an eight stage control signal to a power converter 14. Afterward, the power converter 14 correspondingly generates eight stage charging currents to a lithium ion battery 6 to charge according to the received control signal. As a result, the charging current is further subdivided, and the design space for the power charging system is reduced.

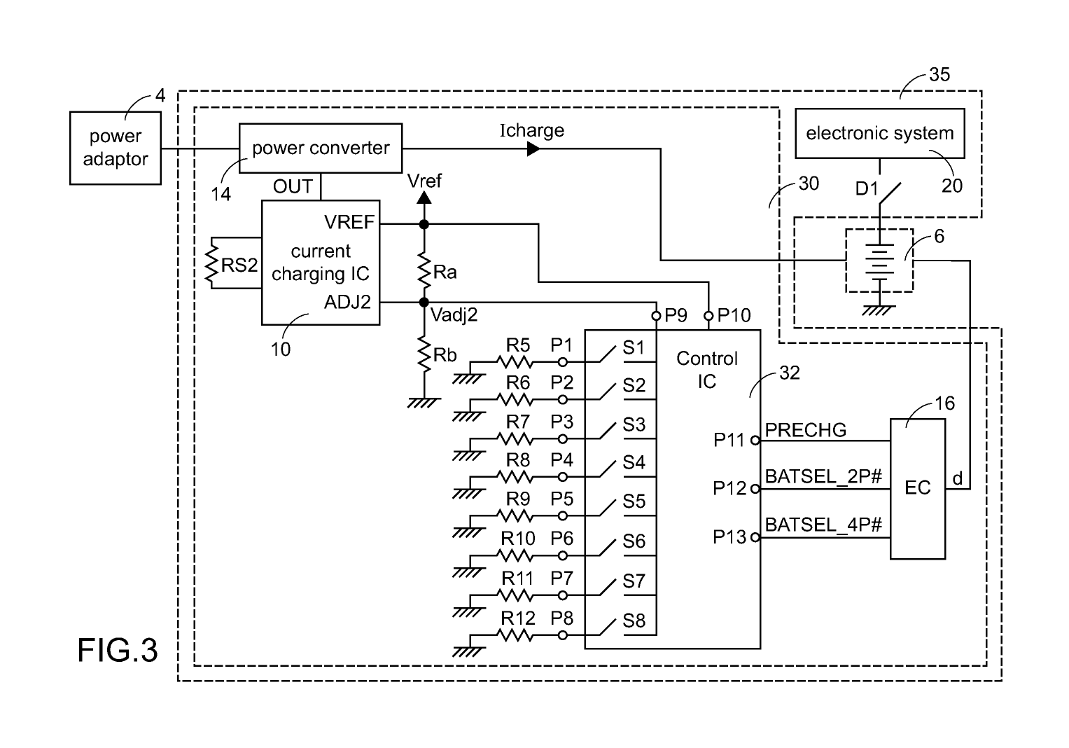

FIG. 3 is a circuit diagram showing a power charging system according to an embodiment of the invention. A power charging system 30 in an electronic device 35 according to the invention is connected between the power adaptor 4 and a lithium ion battery 6, and it mainly includes the current charging IC 10, a control IC 32, the power converter 14, and the EC 16. The power for charging the lithium ion battery 6 is from a direct current outputted by the power adaptor 4. At the same time, the power adaptor 4 may supply power to the electronic device 35. When the power adaptor 4 does not supply power to the electronic device 35, the electricity quantity of the lithium ion battery 6 is supplied to the electronic system 20 of the electronic device 35 via a power change-over switch (D1) which is on. Since the control IC 32 is connected between the current charging IC 10 and the EC 16, the control IC 32 may receive the pre-charging signal PRECHG, the first charging signal BATSEL_2P#, and the second charging signal BATSEL_4P# outputted by the EC 16 for representing the practical electricity quantity of the lithium ion battery 6.

Moreover, a pin P9 of the control IC 32 is connected with the charging current pin ADJ2 of the current charging IC 10. A pin P10 is connected with a reference voltage pin VREF of the current charging IC 10. A pin P1, a pin P2, a pin P3, a pin P4, a pin P5, a pin P6, a pin P7, and a pin P8 are connected with ground via a resistor R5, a resistor R6, a resistor R7, a resistor R8, a resistor R9, a resistor R10, a resistor R11, and a resistor R12, respectively. A pin P11, a pin P12, a pin P13 may receive the pre-charging signal PRECHG, the first charging signal BATSEL_#2, and the second charging signal BATSEL_#4 outputted by the EC 16.

Additionally, in the control IC 32, the pin P9 is connected with the pin P1, the pin P2, the pin P3, the pin P4, the pin P5, the pin P6, the pin P7, and the pin P8 via a switch S1, a switch S2, a switch S3, a switch S4, a switch S5, a switch S6, a switch S7, and a switch S8, respectively. The switch S1, the switch S2, the switch S3, the switch S4, the switch S5, the switch S6, the switch S7, and the switch S8 are controlled to be on and off by the eight configurations (000, 001, 010, 011, 100, 101, 110, 111) composed of the pre-charging signal PRECHG, the first charging signal BATSEL_#2, and the second charging signal BATSEL_#4. That is, controlling the switch S1, the switch S2, the switch S3, the switch S4, the switch S5, the switch S6, the switch S7 and switch 8 to be on or off may be realized by the pre-charging signal PRECHG, the first charging signal BATSEL_#2, and the second charging signal BATSEL_#4 via a multiplexer/demultiplexer.

First, when the EC 16 detects the practical voltage of the lithium ion battery 6 to make the pre-charging signal PRECHG, the first charging signal BATSEL_#2, and the second charging signal BATSEL_#4 outputted by the EC 16 in a first configuration such as (000), the switch Si is on at that moment, and the other seven switches S2, S3, S4, S5, S6, S7, S8 are OFF. The switch S1 which is on makes the resistor R5 first connected with the resistor Rb in parallel and then connected with the resistor Ra in series, and thus the partial voltage of the reference voltage Vref of the reference voltage pin VREF of the current charging IC 10 at the charging current pin ADJ2 is a first voltage, the current charging IC 10 outputs a corresponding control signal to the power converter 14 according to the first voltage received by the charging current pin ADJ2 at that moment, and then the power converter 14 correspondingly generates the charging current Icharge with a first current value to charge the lithium ion battery 6 according to the received control signal. The charging current Icharge with the first current value may be the charging current Icharge 150 mA outputted to the lithium ion battery 6 by the power charging system 30 operated in the pre-charging mode.

Similarly, when the EC 16 detects the practical voltage of the lithium ion battery 6 to make the pre-charging signal PRECHG, the first charging signal BATSEL_#2, and the second charging signal BATSEL_#4 outputted by the EC 16 in a second configuration such as (001), the switch S2 is on at that moment, and the other seven switches S1, S3, S4, S5, S6, S7, S8 are OFF. The switch S2 which is on makes the resistor R6 first connected with the resistor Rb in parallel and then connected with the resistor Ra in series, and thus the partial voltage of the reference voltage Vref of the reference voltage pin VREF of the current charging IC 10 at the charging current pin ADJ2 is a second voltage, the current charging IC 10 outputs a corresponding control signal to the power converter 14 according to the second voltage received by the charging current pin ADJ2 at that moment, and then the power converter 14 correspondingly generates the charging current Icharge with a second current value to charge the lithium ion battery 6 according to the received control signal. The charging current Icharge with the second current value may be the charging current Icharge with the second current value outputted to the lithium ion battery 6 by the power charging system 30 operated in the charging mode.

Similarly, when the EC 16 detects the practical voltage of the lithium ion battery 6 to make the pre-charging signal PRECHG, the first charging signal BATSEL_#2, and the second charging signal BATSEL_#4 outputted by the EC 16 in a third configuration such as (010), the switch S3 is on at that moment, and the other seven switches S1, S2, S4, S5, S6, S7, S8 are OFF. The switch S3 which is on makes the resistor R7 first connected with the resistor Rb in parallel and then connected with the resistor Ra in series, and thus the partial voltage of the reference voltage Vref of the reference voltage pin VREF of the current charging IC 10 at the charging current pin ADJ2 is a third voltage, the current charging IC 10 outputs a corresponding control signal to the power converter 14 according to the third voltage received by the charging current pin ADJ2 at that moment, and then the power converter 14 correspondingly generates the charging current Icharge with a third current value to charge the lithium ion battery 6 according to the received control signal. The charging current Icharge with the third current value may be the charging current Icharge with the third current value outputted to the lithium ion battery 6 by the power charging system 30 operated in the charging mode.

Similarly, when the EC 16 detects the practical voltage of the lithium ion battery 6 to make the pre-charging signal PRECHG, the first charging signal BATSEL_#2, and the second charging signal BATSEL_#4 outputted by the EC 16 in a fourth configuration such as (011), the switch S4 is on at that moment, and the other seven switches S1, S2, S3, S5, S6, S7, S8 are OFF. The switch S4 which is on makes the resistor R8 first connected with the resistor Rb in parallel and then connected with the resistor Ra in series. Thus the partial voltage of the reference voltage Vref of the reference voltage pin VREF of the current charging IC 10 at the charging current pin ADJ2 is a fourth voltage, the current charging IC 10 outputs a corresponding control signal to the power converter 14 according to the fourth voltage received by the charging current pin ADJ2 at that moment, and then the power converter 14 correspondingly generates the charging current Icharge with a fourth current value to charge the lithium ion battery 6 according to the received control signal. The charging current Icharge with the fourth current value may be the charging current Icharge with the fourth current value outputted to the lithium ion battery 6 by the power charging system 30 operated in the charging mode.

Similarly, when the EC 16 detects the practical voltage of the lithium ion battery 6 to make the pre-charging signal PRECHG, the first charging signal BATSEL_#2, and the second charging signal BATSEL_#4 outputted by the EC 16 in a fifth configuration such as (100), the switch S5 is on at that moment, and the other seven switches S1, S2, S3, S4, S6, S7, S8 are OFF. The switch S5 which is on makes the resistor R9 first connected with the resistor Rb in parallel and then connected with the resistor Ra in series, and thus the partial voltage of the reference voltage Vref of the reference voltage pin VREF of the current charging IC 10 at the charging current pin ADJ2 is a fifth voltage, the current charging IC 10 outputs a corresponding control signal to the power converter 14 according to the fifth voltage received by the charging current pin ADJ2 at that moment, and then the power converter 14 correspondingly generates the charging current Icharge with a fifth current value to charge the lithium ion battery 6 according to the received control signal. The charging current Icharge with the fifth current value may be the charging current Icharge with the fifth current value outputted to the lithium ion battery 6 by the power charging system 30 operated in the charging mode.

Similarly, when the EC 16 detects the practical voltage of the lithium ion battery 6 to make the pre-charging signal PRECHG, the first charging signal BATSEL_#2, and the second charging signal BATSEL_#4 outputted by the EC 16 in a sixth configuration such as (101), the switch S6 is on at that moment, and the other seven switches S1, S2, S3, S4, S5, S7, S8 are OFF. The switch S6 which is on makes the resistor R10 first connected with the resistor Rb in parallel and then connected with the resistor Ra in series, and thus the partial voltage of the reference voltage Vref of the reference voltage pin VREF of the current charging IC 10 at the charging current pin ADJ2 is a sixth voltage, the current charging IC 10 outputs a corresponding control signal to the power converter 14 according to the sixth voltage received by the charging current pin ADJ2 at that moment, and then the power converter 14 correspondingly generates the charging current Icharge with a sixth current value to charge the lithium ion battery 6 according to the received control signal. The charging current Icharge with the sixth current value may be the charging current Icharge with the sixth current value outputted to the lithium ion battery 6 by the power charging system 30 operated in the charging mode.

Similarly, when the EC 16 detects the practical voltage of the lithium ion battery 6 to make the pre-charging signal PRECHG, the first charging signal BATSEL_#2, and the second charging signal BATSEL_#4 outputted by the EC 16 in a seventh configuration such as (110), the switch S7 is on at that moment, and the other seven switches S1, S2, S3, S4, S5, S6, S8 are OFF. The switch S7 which is on makes the resistor R11 first connected with the resistor Rb in parallel and then connected with the resistor Ra in series, and thus the partial voltage of the reference voltage Vref of the reference voltage pin VREF of the current charging IC 10 at the charging current pin ADJ2 is a seventh voltage, the current charging IC 10 outputs a corresponding control signal to the power converter 14 according to the seventh voltage received by the charging current pin ADJ2 at that moment, and then the power converter 14 correspondingly generates the charging current Icharge with a seventh current value to the charge lithium ion battery 6 according to the received control signal. The charging current Icharge with the seventh current value may be the charging current Icharge with the seventh current value outputted to the lithium ion battery 6 by the power charging system 30 operated in the charging mode.

Similarly, when the EC 16 detects the practical voltage of the lithium ion battery 6 to make the pre-charging signal PRECHG, the first charging signal BATSEL_#2, and the second charging signal BATSEL_#4 outputted by the EC 16 in a eighth configuration such as (111), the switch S8 is on at that moment, and the other seven switches S1, S2, S3, S4, S5, S6, S7 are OFF. The switch S8 which is on makes the resistor R12 first connected with the resistor Rb in parallel and then connected with the resistor Ra in series, and thus the partial voltage of the reference voltage Vref of the reference voltage pin VREF of the current charging IC 10 at the charging current pin ADJ2 is a eighth voltage, the current charging IC 10 outputs a corresponding control signal to the power converter 14 according to the eighth voltage received by the charging current pin ADJ2 at that moment, and then the power converter 14 correspondingly generates the charging current Icharge with a eighth current value to the lithium ion charge battery 6 according to the received control signal. The charging current Icharge with the eighth current value may be the charging current Icharge with the eighth current value outputted to the lithium ion battery 6 by the power charging system 30 operated in the charging mode.

To sum up, the control IC 32 of the power charging system 30 may make the charging current pin ADJ2 of the current charging IC 10 generate eight voltages with different values according to the eight configurations (000, 001, 010, 011, 100, 101, 110, 111) composed of the received pre-charging signal PRECHG, the first charging signal BATSEL_#2, and the second charging signal BATSEL_#4, and thus the power converter 14 generates eight stage charging currents Icharge to the lithium ion battery 6. As a result, it may improve that the conventional power charging system 2 which only outputs four stage charging currents Icharge to the lithium ion battery 6 according to four configurations composed of the received pre-charging signal PRECHG, the first charging signal BATSEL_#2, and the second charging signal BATSEL_#4, and thus the charging current Icharge is further subdivided. Additionally, since the control circuit 12 in the conventional power charging system 2 is replaced by the control IC 32 in the power charging system 30, the design space for the power charging system is reduced, and eight stage charging currents may be chosen.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A power charging system, connected between a power adaptor and a rechargeable battery, wherein the rechargeable battery is used for supplying power to an electronic system of an electronic device, the power charging system comprising:
an embedded controller (EC) connected with the rechargeable battery and used for outputting a pre-charging signal, a first charging signal, and a second charging signal according to the electricity quantity of the rechargeable battery;
a control integrated circuit (IC) controlling a plurality of switches to be on or off to generate a configuration of a plurality of configurations according to the levels of the received the pre-charging signal, the received first charging signal, and the received second charging signal and correspondingly generating a voltage value according to the configuration;
a current charging IC receiving the voltage value via a charging current pin and outputting a control signal according to the voltage value; and
a power converter converting a direct current outputted by the power adaptor to a charging current with a specific value according to the received control signal to charge the rechargeable battery.

2. The power charging system according to claim 1, wherein the charging current pin of the current charging IC is connected with ground via a first resistor, the charging current pin is connected with a reference voltage pin of the current charging IC via a second resistor, and the reference voltage pin is connected with a reference voltage.

3. The power charging system according to claim 2, wherein the control IC further comprises:
a first pin connected with the charging current pin; and
a second pin connected with the reference voltage pin.

4. The power charging system according to claim 1, wherein the number of the switches is eight, and the eight switches are connected with ground via eight resistors, respectively.

5. The power charging system according to claim 4, wherein the eight switches are connected with a multiplexer/demultiplexer, and the eight switches are controlled to be on and off via the pre-charging signal, the first charging signal, and the second charging signal outputted to the multiplexer/demultiplexer.

6. The power charging system according to claim 1, wherein the electronic device is a notebook computer system, a personal digital assistant (PDA), or a handheld telephone.

7. The power charging system according to claim 1, wherein the rechargeable battery is a lithium ion battery.
